(19) United States
(12) Patent Application Publication
(10) Pub. No.: US 2025/0169500 A1
(43) Pub. Date: May 29, 2025

(54) METHOD AND APPARATUS FOR CONTROLLING WEEDS BY POST-HARVEST TREATMENT OF WEED SEEDS

(71) Applicants: BAYER CROPSCIENCE LP, St. Louis, MO (US); COLORADO STATE UNIVERSITY RESEARCH FOUNDATION (CSURF), Fort Collins, CO (US)

(72) Inventors: Scott NISSEN, Fort Collins, CO (US); Rachel SEEDORF, Fort Collins, CO (US); Shannon CLARK, Cary, NC (US); Harold QUICKE, Cary, NC (US); David R. SPAK, Cary, NC (US)

(21) Appl. No.: 18/844,088

(22) PCT Filed: Mar. 9, 2023
(86) PCT No.: PCT/IB2023/052277

§ 371 Date: Sep. 5, 2024

Related U.S. Application Data
(60) Provisional application No. 63/318,627, filed on Mar. 10, 2022.

(51) Int. Cl. A01N 43/68; A01P 13/00

(52) U.S. Cl. CPC A01N 43/68; A01P 13/00

(57) ABSTRACT

Methods, compositions, and apparatus for controlling undesired vegetation, such as invasive annual grasses, by treating seeds or seedheads.

### CROSS-REFERENCE TO RELATED APPLICATIONS

This patent application is an international application which claims priority to U.S. Provisional Patent Application No. 63/318,627, filed Mar. 10, 2022, the disclosure of which is incorporated herein in its entirety.

### FIELD

The present disclosure provides methods and apparatus for preventing or inhibiting seed germination of harmful or undesired plants.

### BACKGROUND

There is an ongoing need for methods of preventing or inhibiting seed germination in harmful or invasive plants, such as weeds and other undesired plants. Harmful and undesired plants include, for example, invasive grasses, e.g., buffelgrass, cheatgrass, ventenata, medusahead, vaseygrass, sandbur, crabgrass, jointed goatgrass, and invasive broadleaves, e.g., pigweed, kochia, waterhemp, Palmer amaranth, Russian thistle.

Cellulose biosynthesis inhibitors such as indaziflam are known herbicides, known to be particularly effective at controlling undesirable monocot and dicot plants.

The present inventors have surprisingly found that herbicides of the class known as cellulose biosynthesis inhibitors, such as indaziflam, when applied as described herein, inhibit or prevent seed germination in harmful plants, such as weeds and other undesired plant pests.

### SUMMARY

The present disclosure provides for methods of preventing seed germination, wherein a composition comprising a cellulose biosynthesis inhibitor herbicide such as indaziflam is applied to a seed of a plant or applied to a seedhead or inflorescence of a plant in a reproductive stage of growth.

The present disclosure also provides for a method for preventing germination of a seed or for destroying a plant from which the seed grows, the method comprising applying to the seed, while harvesting or destroying a plant from which the seed has been produced, a seed-germination preventative amount and/or a plant-destroying amount of an herbicidal composition.

The present disclosure also provides for an apparatus adapted to travel on the ground with a crop harvesting machine, or integrated with a crop harvesting machine, the apparatus configured to be positioned in an output stream of a crop residue material produced by the harvesting machine, the apparatus comprising an input port to receive the crop residue material and an applicator configured to apply a liquid or other composition to the crop and/or weed residue.

It has been found that compositions comprising indaziflam can unexpectedly inhibit seed growth, particularly in unwanted plants.

Further objects, features, and advantages of the methods and apparatus of the present disclosure will become apparent from the detailed description that follows and are met in whole or in part.

### DETAILED DESCRIPTION

Applicant has now found that, surprisingly, compositions comprising an herbicide of the class known as cellulose biosynthesis inhibitors, indaziflam, can be applied to a seed of a plant or to a seedhead of a plant in a reproductive stage of plant growth to inhibit seed growth, particularly in unwanted plants. According to the present disclosure, any cellulose biosynthesis inhibitor may be used, alone or in combination with other active or inactive ingredients.

Previously, it has been observed that compositions comprising indaziflam possess outstanding growth-regulatory properties when indaziflam comes in contact with root meristems of plants. Moreover, compositions comprising indaziflam have been recognized as being suitable for generally controlling and inhibiting undesired vegetative growth of plants in the seedling stage of growth without simultaneously killing the desirable perennial crop plants. What has not been known and is therefore surprising and unexpected in light of the known herbicidal properties and uses of indaziflam-containing products, is that compositions comprising a cellulose biosynthesis inhibitor such as indaziflam can be applied to a seed of a plant or to a seedhead of a plant in the reproductive stage of growth to inhibit seed growth.

The compound indaziflam, used in the present claimed methods and apparatus, is described in, for example, U.S. Pat. No. 8,114,991, which is hereby incorporated by reference in its entirety. The compound taught by U.S. Pat. No. 8,114,991 is described therein as having herbicidal properties. See U.S. Pat. No. 8,114,991 at, for example, column 62, line 22 to column 72, line 43. This patent teaches that indaziflam is a plant growth regulator, also known as a plant growth retardant. Accordingly, indaziflam's ability to inhibit seed growth is surprising in light of its known use as a plant growth regulator and retardant.

Indaziflam's International Union of Pure and Applied Chemistry (IUPAC) name is 2-N-[(1R,2S)-2,3-dihydro-2,6-dimethyl-1H-inden-1-yl]-6-[(1RS)-1-fluoroethyl]-1,3,5-triazine-2,4-diamine. Indaziflam is written chemically as C₁₆H₂₀FN₅.

Indaziflam is an alkylazine compound characterized as a cellulose biosynthesis inhibitor, belonging to Weed Science Society of America (“WSSA”) Mode of Action group 29.

Additional cellulose biosynthesis inhibitors include herbicides belonging to benzamide (WSSA group 21), nitrile (WSSA group 20), and triazolocarboxamides (WSSA group 28) classes of chemicals. For example, cellulose biosynthesis inhibitors of the benzamide family include isoxaben. Cellulose biosynthesis inhibitors of the nitrile family include dichlobenil and chlorthiamid. Cellulose biosynthesis inhibitors of the triazolocarboxamide family include flupoxam.

Cellulose biosynthesis inhibitor herbicides affect synthesis of the cellulose needed for cell walls in susceptible plants, thereby inhibiting cell division. These herbicides are absorbed through susceptible plants' roots and shoot tissues and inhibit root and shoot growth.

Commercially available herbicides incorporating indaziflam as their active ingredient include, for example, Alion®, Esplanade® EZ, Esplanade® 200 SC, Rejuvra®, Rezilon® Specticle® G. Specticle® FLO, Specticle® Total, Specticle® 20 WSP, Marengo®, and DuraZone®. Any of these can be used in the present disclosure. In an aspect, the methods use indaziflam as the only active component. For example, in an aspect, the composition used in the methods does not include other herbicides, fungicides, insecticides, or other agriculturally active components.

Indaziflam is known to be useful as a pre-emergence herbicide for annual grasses and broadleaf weeds. Indaziflam has been approved for use on residential and commercial property such as golf courses, lawns, walkways, cemeteries, evergreen nurseries, landscaping projects, crops, rangeland and pasture, and vegetation management markets.

Herbicidal compositions comprising indaziflam are commonly used to control pests such as annual grasses and broadleaf weeds. Indaziflam works well against, for example, cheatgrass, ventenata, medusahead, annual ryegrass, crabgrass, goosegrass, kyllinga, annual bluegrass, doveweed, swinecress, bittercress and henbit, including all weeds listed on the labels of the commercial products.

In contrast to these known uses, it has surprisingly been found that application of indaziflam directly to a seed or to a seedhead of a plant in the reproductive stage of growth inhibits or prevents seed germination.

The composition comprising a cellulose biosynthesis inhibitor is applied to a seed of a plant or to a seedhead of a plant in a seedhead growth stage to prevent seed germination or to destroy a plant from which the seed grows. The composition can include any desired amount of the cellulose biosynthesis inhibitor, such as wherein said cellulose biosynthesis inhibitor is present at a concentration of 0.0001% to 20%, or 0.001% to 10%, or 0.01% to 1%, or 0.1% to 0.5% by weight of the composition.

In another aspect, the disclosure provides for a method described herein, wherein a composition comprising a cellulose biosynthesis inhibitor is applied to a seed of a plant or to a seedhead of a plant in the reproductive stage of plant growth to prevent or inhibit seed germination, at a rate which provides the desired results without adversely affecting a desired plant, for example, at a rate of 0.1 to 500 grams of active ingredient per hectare (hereinafter, “g ai/ha”), 0.5 to 200 g ai/ha, 1.0 to 100 g ai/ha, 2 to 50 g ai/ha or 2 to 25 g ai/ha.

In an aspect, the cellulose biosynthesis inhibitor is applied on a per-hectare rate basis—for example, at a rate from about 1 to about 50 g ai/ha. In another aspect, the cellulose biosynthesis inhibitor is applied at a rate from about 2 to about 50 g ai/ha, from about 2 to about 40 g ai/ha, from about 2 to about 35 g ai/ha, from about 2 to about 30 g/ha, from about 2 to about 25 g ai/ha, from about 2 to about 20 g ai/ha, from about 2 to about 15 g ai/ha, from about 2 to about 10 g ai/ha, from about 2 to about 5 g ai/ha, from about 5 to about 50 g ai/ha, from about 5 to about 40 g ai/ha, from about 5 to about 35 g ai/ha, from about 5 to about 30 g ai/ha, from about 5 to about 25 g ai/ha, from about 5 to about 20 g ai/ha, from about 5 to about 15 g ai/ha, from about 5 to about 10 g ai/ha, from about 10 to about 50 g ai/ha, from about 10 to about 40 g ai/ha, from about 10 to about 35 g ai/ha, from about 10 to about 30 g ai/ha, from about 10 to about 25 g ai/ha, from about 10 to about 20 g ai/ha, from about 10 to about 15 g ai/ha, from about 15 to about 50 g ai/ha, from about 15 to about 40 g ai/ha, from about 15 to about 35 g ai/ha, from about 15 to about 30 g ai/ha, from about 15 to about 25 g ai/ha, from about 15 to about 20 g ai/ha, from about 20 to about 50 g ai/ha, from about 20 to about 40 g ai/ha, from about 20 to about 35 g ai/ha, from about 20 to about 30 g ai/ha, from about 20 to about 25 g ai/ha, from about 25 to about 50 g ai/ha, from about 25 to about 40 g ai/ha, from about 25 to about 35 g ai/ha, or from about 25 to about 30 g ai/ha.

The present disclosure also provides for a method for preventing germination of a seed or for destroying a plant from which the seed grows, the method comprising applying to the seed, while harvesting or destroying a plant from which the seed has been produced, a seed-germination preventative amount and/or a plant-destroying amount of an herbicidal composition comprising a cellulose biosynthesis inhibitor. In an aspect, the plant from which the seed has been produced is harvested and/or destroyed while, or after, harvesting a crop at a locus where the plant had been growing before the harvesting. In an aspect, the plant is selected from invasive grasses, e.g., buffelgrass, cheatgrass, ventenata, medusahead, vaseygrass, sandbur, crabgrass, jointed goatgrass, and invasive broadleaves, e.g., pigweed, kochia, waterhemp, Palmer amaranth, Russian thistle. In an aspect, the crop comprises cotton, soybean, wheat, or corn. In an aspect, the cellulose biosynthesis inhibitor (e.g., indaziflam) is applied at a rate of from about 1 to about 50 g ai/ha. In an aspect, weed and crop plants are growing together and can be harvested together. In another aspect, weed and crop plants are not growing together and are not harvested together.

The present disclosure also provides for an apparatus adapted to travel on the ground with a crop harvesting machine, or integrated with a crop harvesting machine, the apparatus configured to be positioned in an output stream of a crop residue material produced by the harvesting machine, the apparatus comprising an input port to receive the crop residue material and an applicator configured to apply a liquid to the crop residue.

In an aspect, the apparatus further comprises a mill for fragmentation of the crop residue material to provide a fragmented crop residue.

In an aspect, the applicator is configured to apply one or more streams of liquid to the crop residue.

In an aspect, the applicator is configured to apply an aspirated liquid to the fragmented crop residue.

In an aspect, the liquid is an agrochemically acceptable liquid.

In an aspect, the liquid comprises a cellulose biosynthesis inhibitor. In another aspect, the cellulose biosynthesis inhibitor is indaziflam.

In an aspect, the apparatus is configured to apply the indaziflam at a rate of from about 1 to about 50 g ai/ha of indaziflam as the crop harvesting machine deposits crop residue material about the traveled land. In another aspect, the indaziflam is applied at any of the following rates (g indaziflam per hectare of traveled land): from about 2 to about 50 g ai/ha, from about 2 to about 40 g ai/ha, from about 2 to about 35 g ai/ha, from about 2 to about 30 g/ha, from about 2 to about 25 g ai/ha, from about 2 to about 20 g ai/ha, from about 2 to about 15 g ai/ha, from about 2 to about 10 g ai/ha, from about 2 to about 5 g ai/ha, from about 5 to about 50 g ai/ha, from about 5 to about 40 g ai/ha, from about 5 to about 35 g ai/ha, from about 5 to about 30 g ai/ha, from about 5 to about 25 g ai/ha, from about 5 to about 20 g ai/ha, from about 5 to about 15 g ai/ha, from about 5 to about 10 g ai/ha, from about 10 to about 50 g ai/ha, from about 10 to about 40 g ai/ha, from about 10 to about 35 g ai/ha, from about 10 to about 30 g ai/ha, from about 10 to about 25 g ai/ha, from about 10 to about 20 g ai/ha, from about 10 to about 15 g ai/ha, from about 15 to about 50 g ai/ha, from about 15 to about 40 g ai/ha, from about 15 to about 35 g ai/ha, from about 15 to about 30 g ai/ha, from about 15 to about 25 g ai/ha, from about 15 to about 20 g ai/ha, from about 20 to about 50 g ai/ha, from about 20 to about 40 g ai/ha, from about 20 to about 35 g ai/ha, from about 20 to about 30 g ai/ha, from about 20 to about 25 g ai/ha, from about 25 to about 50 g ai/ha, from about 25 to about 40 g ai/ha, from about 25 to about 35 g ai/ha, or from about 25 to about 30 g ai/ha.

In any of the above aspects, the cellulose biosynthesis inhibitor may be indaziflam.

The composition comprising a cellulose biosynthesis inhibitor can be formulated in any desired manner and include any desired excipients.

The product used can be a commercial formulation which contains various formulation additives.

The compositions can be formulated as a granular formulation, seed treatment, solutions, emulsions, suspension, coating formulation, encapsulated formulation, solid, liquid, fertilizer, paste, powder, suspension, or suspension concentrate. The composition may be employed alone or in solid, dispersant, or liquid formulation. In yet another aspect, a composition described herein is formulated as a tank-mix product.

These formulations are produced in any desired or known manner, for example by mixing the active compounds with extenders, such as liquid solvents, pressurized liquefied gases and/or solid carriers, optionally with the use of surface-active agents, such as emulsifiers and/or dispersants and/or foam formers. If the extender used is water, it is also useful to employ for example organic solvents as cosolvents. Suitable liquid solvents include: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and also water. Liquefied gaseous extenders or carriers include those liquids which are gaseous at ambient temperature and at atmospheric pressure, for example aerosol propellants such as halogenated hydrocarbons and also butane, propane, nitrogen and carbon dioxide. As solid carriers there are suitable: for example, ground natural minerals, such as kaolins, clays, talc, chalk, quartz, attapulgite, montmorillonite or diatomaceous earth, and ground synthetic minerals, such as finely divided silica, alumina and silicates. As solid carriers for granules there are suitable: for example, crushed and fractionated natural rocks such as calcite, pumice, marble, sepiolite and dolomite, and also synthetic granules of inorganic and organic meals, and granules of organic material such as sawdust, coconut shells, maize cobs and tobacco stalks. As emulsifiers and/or foam formers there are suitable: for example, non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and protein hydrolysates. As dispersants, for example, lignosulphite waste liquors and methylcellulose are suitable.

Tackifiers such as carboxymethylcellulose and natural and synthetic polymers in the form of powders, granules or latices, such as gum arabic, polyvinyl alcohol and polyvinyl acetate, as well as natural phospholipids, such as cephalins and lecithins, and synthetic phospholipids, can be used in the formulations. Other possible additives are mineral and vegetable oils.

Colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc, can also be used.

In an aspect, compositions comprising a cellulose biosynthesis inhibitor is applied to a seed or seedhead of a monocotyledonous plant. In another aspect, said compositions are applied to annual broadleaf and grass crops. In certain aspects, the plant is buffelgrass, cheatgrass, ventenata, medusahead, vaseygrass, sandbur, crabgrass, jointed goatgrass, and invasive broadleaves, e.g., pigweed, kochia, waterhemp, Palmer amaranth, Russian thistle.

A composition described herein can be applied to a soil, plant, crop, seed, seedhead, leaf, or plant part thereof in a single application step. In an aspect, a composition described herein is applied to a seed or seedhead of a plant in a reproductive stage of growth. In another aspect, a composition described herein is applied to a plant, crop, seed, seedhead, leaf, or plant part thereof in multiple application steps, for example, two, three, four, five or more application steps. In another aspect, the second, third, fourth, or fifth or more application steps may be with the same or different compositions. The methods described herein also provide for an aspect where multiple application steps are excluded.

A composition described herein can be applied to a soil, plant, crop, seed, seedhead or plant part thereof in one or more application intervals of about 30 minutes, about 1 hour, about 2 hours, about 6 hours, about 8 hours, about 12 hours, about 1 day, about 5 days, about 7 days, about 10 days, about 12 days, about 14 days, about 21 days, about 28 days, about 35 days, about 45 days, about 50 days, or about 56 days. In an aspect, the composition described herein can be applied one time, two times, three times, four times, or five times per harvest. In an aspect the composition described herein can be applied more than five times per harvest. In an aspect, the composition described herein can be applied once per harvest. In an aspect, the composition described herein can be applied one time, two times, three times, four times, or five times post-harvest. In an aspect the composition described herein can be applied more than five times post-harvest. In an aspect, the composition described herein can be applied once post-harvest.

A composition described herein can be applied to a plant, crop, seed, seedhead or plant part thereof one or more times during a growing, planting, or harvesting season. In another aspect, a compound or composition described herein is applied to a plant, crop, seed, seedhead or plant part thereof in one, two, three, four, or five or more times during a growing, planting, or harvesting season. In another aspect, a compound or composition described herein is applied to a plant, crop, seed, seedhead or plant part thereof only one time, no more than two times, or no more than three times during a growing, planting, or harvesting season. In yet another aspect, a compound or composition is applied in a single step to a seed. In yet another aspect, a seed described herein is planted in a one-pass application step. In yet another aspect, a compound or composition described herein is applied to a seed or seedhead of a plant in a seedhead growth stage during a harvesting season.

Methods described herein can be used in the treatment of genetically modified organisms (GMOs), e.g., plants or seeds. Genetically modified plants (or transgenic plants) are plants of which a heterologous gene has been stably integrated into genome. The expression “heterologous gene” essentially means a gene which is provided or assembled outside the plant and when introduced in the nuclear, chloroplastic or mitochondrial genome gives the transformed plant new or improved agronomic or other properties by expressing a protein or polypeptide of interest or by downregulating or silencing other gene(s) which are present in the plant (using for example, antisense technology, cosuppression technology or RNA interference-RNAi-technology). A heterologous gene that is located in the genome is also called a transgene. A transgene that is defined by its particular location in the plant genome is called a transformation or transgenic event.

In an aspect, plants can be obtained by traditional breeding and optimization methods or by biotechnological and recombinant methods, or combinations of these methods, including the transgenic plants and including the plant varieties which are capable or not capable of being protected by Plant Breeders' Rights.

In another aspect, plant species and plant varieties which are found in the wild or which are obtained by traditional biological breeding methods, such as hybridization or protoplast fusion, and parts of these species and varieties are treated. In a further aspect, transgenic plants and plant varieties which were obtained by recombinant methods, if appropriate in combination with traditional methods (genetically modified organisms) and their parts are treated.

“Plant parts” should be understood as meaning all above ground and subsoil parts and organs of plants, such as shoot, leaf, flower, root, leaves, needles, stalks, stems, fruiting bodies, fruits and seeds, tubers and rhizomes. Plant parts also include harvested crops, and also vegetative and generative propagation material, for example cuttings, tubers, rhizomes, slips and seeds.

Seeds, seedheads, plant parts, leaves, and plants may be treated with the described compositions by applying the compounds or compositions directly to the seed, seedhead, plant part, leaf, or plant. In another aspect, the seed, plant part, leaf, or plant may be treated indirectly, for example by treating the environment or habitat in which the seed, plant part, leaf, or plant is exposed to. Conventional treatment methods may he used to treat the environment or habitat including dipping, spraying, fumigating, chemigating, fogging, scattering, brushing on, shanking or injecting.

“Habitat” denotes where a plant or crop is growing or where a plant or crop will be grown. The composition can be used to treat the plant, crop, or habitat thereof.

According to the disclosure, the treatment of the plants and seeds with a composition described herein can be carried out directly by the customary treatment methods, for example by immersion, spraying, vaporizing, fogging, injecting, dripping, drenching, broadcasting or painting, and seed treatment.

A compound or composition described herein can take any of a variety of dosage forms including, without limitation, suspension concentrates, aerosols, capsule suspensions, cold-fogging concentrates, warm-togging concentrates, encapsulated granules, fine granules, flowable concentrates for the treatment of seed, ready-to-use solutions, dustable powders, emulsifiable concentrates, oil-in-water emulsions, water-in-oil emulsions, macrogranules, microgranules, oil-dispersible powders, oil-miscible flowable concentrates, oil-miscible liquids, foams, pastes, pesticide-coated seed, suspoemulsion concentrates, soluble concentrates, wettable powders, soluble powders, dusts and granules, water-soluble granules or tablets, water-soluble powders for the treatment of seed, wettable powders, natural products and synthetic substances impregnated with a compound or composition described herein, a net impregnated with a compound or composition described herein, and also microencapsulations in polymeric substances and in coating materials for seed, and also UV cold-fogging and warm-fogging formulations.

A composition disclosed herein may optionally include one or more additional compounds providing an additional beneficial or otherwise useful effect. Such compounds include, without limitation, an adhesive, a surfactant, a solvent, a wetting agent, an emulsifying agent, a carrier, an adjuvant, a diluent, a dispersing agent an insecticide, a pesticide, a fungicide, a fertilizer of a micronutrient or macronutrient nature, a herbicide, a feeding inhibitor, an insect molting inhibitor, an insect mating inhibitor, an insect maturation inhibitor, a nematicide, a nutritional or horticultural supplement, or any combination thereof. In an aspect, a composition described herein is odor free.

Compositions described herein can be combined with a fertilizer. Examples of fertilizers capable of being used with the compositions and methods described herein include, for example, urea, ammonium nitrate, ammonium sulfate, calcium nitrate, diammonium phosphate, monoammonium phosphate, triple super phosphate, potassium nitrate, potassium nitrate, nitrate of potash, potassium chloride, muriate of potash, di- and mono-potassium salts of phosphite/phosphonate. In an aspect, methods and compositions of the present invention may be used to control any weed, including Abelmoschus esculentus, Abrus precatorius, Abutilon theophrasti, Acacia auriculiformis, Acacia confuse, Acacia mearnsii, Acacia melanoxylon, Acacia paradoxa, Acacia parramattensis, Acaena novae-zelandiae, Acaena pallida, Acalypha ostryifolia, Acalypha virginica, Acanthospermum hispidum, Acer ginnala, Acer negundo, Acer platanoides, Acer pseudoplatanus, Acer rubrum, Achillea millefolium, Achillea millefolium var. occidentalis, Achnathe rum brachychae turn, Acroptilon repens, Adenanthera pavonina, Aegilops cylindrica, Aegilops geniculate, Aegilops triuncialis, Aeginetia, Aegopodium podagraria, Aeschynomene indica, Aeschynomene rudis, Aeschynomene virginica, Agave sisalana, Ageratina adenophora, Ageratina altissima var. altissima, Ageratina riparia, Agrostemma githago, Agrostis stolonifera, Ailanthus altissima, Albizia julibrissin, Albizia lebbeck, Alectra, Alhagi maurorum, Alliaria petiolata, Allium, Allium canadense, Allium neapolitanum, Allium paniculatum, Allium textile, Allium vineale, Allium vineale ssp. compactum, Alnus glutinosa, Alopecurus carolinianus, Alopecurus myosuroides, Alstonia macrophylla, Altemanthera, Altemanthera philoxeroides, Altemanthera pungens, Alternanthera sessilis, Alyssum alyssoides, Amaranthus albus, Amaranthus blitoides, Amaranthus hybridus, Amaranthus palmeri, Amaranthus powellii, Amaranthus retroflexus, Amaranthus spinosus, Amaranthus tube rculatus, Amaranthus viridis, Ambrosia acanthicarpa, Ambrosia artemisiifolia, Ambrosia artemisiifolia var. elatior, Ambrosia grayi, Ambrosia psilostachya, Ambrosia tomentosa, Ambrosia trifida, Ammannia coccinea, Ammophila arenaria, Amorpha fruticosa, Ampelopsis brevipedunculata, Amphiachyris dracunculoides, Amsinckia menziesii var. intermedia, Anagallis arvensis, Anchusa arvensis, Anchusa officinalis, Andropogon bicomis, Andropogon gerardii, Andropogon virginicus, Anemone hupehensis, Angiopteris evecta, Anoda cristata, Anredera cordifolia, Anredera vesicaria, Anthemis arvensis, Anthemis cotula, Anthriscus sylvestris, Antigonon leptopus, Apocynum androsaemifolium, Apocynum cannabinum, Arabidopsis thaliana, Araujia sericifera, Archontophoenix alexandrae, Arctium minus, Arctotheca calendula, Ardisia crenata, Ardisia elliptica, Argemone mexicana, Argemone polyanthemos, Aristida oligantha, Aristida purpurea, Aristolochia elegans, Arrhenathe rum elatius var. bulbosum, Artemisia absinthium, Artemisia annua, Artemisia biennis, Artemisia campestris, Artemisia cana, Artemisia dracunculus, Artemisia filifolia, Artemisia frigida, Artemisia ludoviciana, Artemisia tridentata, Artemisia vulgaris, Arthraxon hispidus, Arthrostemma ciliatum, Arundo donax, Asclepias fascicularis, Asclepias incamata, Asclepias labriformis, Asclepias physocarpa, Asclepias speciosa, Asclepias subverticillata, Asclepias syriaca, Asclepias verticillata, Asparagus aethiopicus, Asphodelus fistulosus, Astragalus bisulcatus, Astragalus missouriensis, Astragalus mollissimus, Asystasia gangetica, Atriplex semibaccata, Atriplex subspicata, Avena barbata, Avena fatua, Avena sativa, Avena sterilis, Axonopus fissifolius, Azolla pinnata, Bacopa rotundifolia, Barbarea orthoceras, Barbarea vulgaris, Bassia hyssopifolia, Bassia scoparia, Bauhinia variegata, Begonia cucullata, Bellardia trixago, Bellis perennis, Berberis, Berberis thunbergii, Berberis vulgaris, Berteroa incana, Bidens alba, Bidens aristosa, Bidens bipinnata, Bidens cemua, Bidens cynapiifolia, Bidens frondosa, Bidens pilosa, Bischofia javanica, Bocconia frutescens, Bouteloua dactyloides, Brachypodium distachyon, Brachypodium sylvaticum, Brassica, Brassica juncea, Brassica nigra, Brassica rapa, Brassica toumefortii, Brickellia eupatorioides var. eupatorioides, Bromus arvensis, Bromus carinatus, Bromus catharticus, Bromus diandrus, Bromus diandrus ssp. rigidus, Bromus hordeaceus, Bromus hordeaceus ssp. hordeaceus, Bromus inermis, Bromus japonicus, Bromus racemosus, Bromus rubens, Bromus secalinus, Bromus sterilis, Bromus tectorum, Broussonetia papyrifera, Bruguiera sexangula, Brunnichia ovata, Bryonia alba, Bryum argenteum, Buddleja davidii, Buglossoides arvensis, Bupleurum rotundifolium, Butomus umbellatus, Cabomba caroliniana, Caesalpinia decapetala, Calandrinia ciliata, Callirhoe involucrata, Callitriche stagnalis, Calophyllum antillanum, Calystegia sepium, Calystegia sepium ssp. sepium, Came lina microcarpa, Campanula rapunculoides, Campsis radicans, Cannabis sativa, Caperonia palustris, Capsella bursa-pastoris, Cardamine hirsuta, Cardamine impatiens, Cardamine parviflora, Cardaria chalepensis, Cardaria draba, Cardaria pubescens, Cardiospermum halicacabum, Carduus, Carduus acanthoides, Carduus crispus, Carduus nutans, Carduus pycnocephalus, Carduus tenuiflorus, Carex kobomugi, Carpobrotus edulis, Carthamus lanatus, Carthamus lanatus ssp. creticus, Carthamus leucocaulos, Carthamus oxyacanthus, Carum carvi, Castilla elastica, Casuarina, Casuarina equisetifolia, Casuarina glauca, Caulerpa taxifolia, Cecropia obtusifolia, Celastrus orbiculatus, Cenchrus echinatus, Cenchrus longispinus, Cenchrus spinifex, Centaurea calcitrapa, Centaurea cyanus, Centaurea diffusa, Centaurea iberica, Centaurea jacea, Centaurea macrocephala, Centaurea melitensis, Centaurea nigra, Centaurea nigrescens, Centaurea solstitialis, Centaurea stoebe ssp. micranthos, Centaurea sulphurea, Centaurea virgata, Centaurea virgata ssp. squarrosa, Centromadia pungens ssp. pungens, Cerastium fontanum, Cerastium fontanum ssp. vulgare, Ceratocephala testiculata, Cereus hildmannianus, Cestrum diumum, Cestrum noctumum, Chaenorhinum minus, Chamaecrista fasciculata var. fasciculata, Chamaesyce glyptosperma, Chamaesyce humistrata, Chamaesyce hyssopifolia, Chamaesyce maculata, Chamaesyce nutans, Chamerion angustifolium ssp. angustifolium, Chenopodium album, Chenopodium berlandieri, Chenopodium leptophyllum, Chenopodium murale, Chenopodium simplex, Chloris verticillata, Chloris virgata, Chondrilla juncea, Chorispora tenella, Chromolaena odorata, Chrysophyllum cainito, Chrysophyllum mexicanum, Chrysophyllum oliviforme, Chrysopogon aciculatus, Chrysothamnus viscidiflorus, Cichorium intybus, Cicuta douglasii, Cicuta maculata, Cinchona pubescens, Cinnamomum burmannii, Cinnamomum camphora, Cirsium, Cirsium altissimum, Cirsium arvense, Cirsium canescens, Cirsium discolor, Cirsium flodmanii, Cirsium foliosum, Cirsium horridulum, Cirsium japonicum, Cirsium ochrocentrum, Cirsium undulatum, Cirsium vulgare, Citharexylum caudatum, Citharexylum spinosum, Citrullus lanatus var. lanatus, Citrus reticulata ssp. unshiu, Claytonia perfoliata ssp. perfoliata, Clematis orientalis, Clematis temiflora, Clematis virginiana, Clematis vitalba, Cleome gynandra, Cleome serrulata, Clerodendrum bungei, Clerodendrum chinense, Clerodendrum macrostegium, Clidemia hirta, Clidemia hirta var. hirta, Clusia rosea, Cnicus benedictus, Coccinia grandis, Cocculus carolinus, Colocasia esculenta, Colubrina asiatica, Commelina benghalensis, Commelina communis, Commelina diffusa, Conicosia pugioniformis, Conium maculatum, Conoclinium coelestinum, Convallaria majalis, Convolvulus arvensis, Conyza bonariensis, Conyza canadensis, Coreopsis tinctoria, Coronopus didymus, Coronopus squamatus, Cortaderia jubata, Cortaderia selloana, Corynocarpus laevigatus, Cosmos bipinnatus, Cosmos sulphureus, Cotoneaster lacteus, Cotoneaster pannosus, Crassula helmsii, Crataegus monogyna, Crepis setosa, Crotalaria, Crotalaria spectabilis, Croton capitatus, Croton glandulosus, Croton setigerus, Croton texensis, Crupina vulgaris, Cryptostegia madagascariensis, Cucumis anguria, Cucumis melo, Cucumis myriocarpus, Cucurbita foetidissima, Cupaniopsis anacardioides, Cuscuta, Cuscuta approximata, Cuscuta boldinghii, Cuscuta cassytoides, Cuscuta epilinum, Cuscuta epithymum, Cuscuta europaea, Cuscuta indecora, Cuscuta indecora var. bifida, Cuscuta indecora var. indecora, Cuscuta indecora var. longisepala, Cuscuta indecora var. neuropetala, Cuscuta japonica, Cuscuta pentagona, Cuscuta pentagona var. glabrior, Cuscuta pentagona var. pentagona, Cuscuta pentagona var. pubescens, Cuscuta reflexa, Cuscuta suaveolens, Cuscuta umbellata, Cyathea cooperi, Cyclachaena xanthiifolia, Cymbopogon refractus, Cynanchum laeve, Cynanchum louiseae, Cynanchum rossicum, Cynanchum vincetoxicum, Cynara cardunculus, Cynodon, Cynodon dactylon, Cynoglossum officinale, Cyperus acuminatus, Cyperus compressus, Cyperus difformis, Cyperus erythrorhizos, Cyperus esculentus, Cyperus haspan, Cyperus involucratus, Cyperus iria, Cyperus odoratus, Cyperus prolifer, Cyperus rotundus, Cyperus strigosus, Cytisus scoparius, Cytisus scoparius var. andreanus, Cytisus scoparius var. scoparius, Cytisus striatus, Dactylis glomerata, Dactyloctenium aegyptium, Daphne laureola, Datura inoxia, Datura quercifolia, Datura stramonium, Daucus carota, Delairea odorata, Delphinium carolinianum ssp. virescens, Delphinium geyeri, Delphinium nuttallianum, Delphinium xoccidentale, Deparia petersenii, Descurainia pinnata, Descurainia sophia, Desmanthus illinoensis, Desmodium cajanifolium, Desmodium tortuosum, Dianthus armeria, Dichrostachys cinerea, Digitalis purpurea, Digitaria abyssinica, Digitaria bicornis, Digitaria ciliaris, Digitaria ischaemum, Digitaria sanguinalis, Digitaria velutina, Diodia teres, Diodia virginiana, Dioscorea alata, Dioscorea bulbifera, Dioscorea oppositifolia, Dipsacus fullonum, Dipsacus laciniatus, Dipsacus sativus, Dissotis rotundifolia, Distichlis spicata, Draba vema, Dracopis amplexicaulis, Drymaria arenarioides, Dysphania ambrosioides, Dyssodia papposa, Echinochloa colona, Echinochloa crus-galli, Echinocystis lobata, Echinodorus cordifolius, Echium plantagineum, Echium vulgare, Eclipta prostrata, Egeria densa, Ehrharta calycina, Ehrharta erecta, Eichhornia, Eichhornia azurea, Eichhornia crassipes, Elaeagnus angustifolia, Elaeagnus pun gens, Elaeagnus umbellata, Elephantopus mollis, Eleusine indica, Ellisia nyctelea, Elodea canadensis, Elsholtzia ciliata, Elymus repens, Emex australis, Emex spinosa, Enterolobium contortisiliquum, Epilobium hirsutum, Epipremnum pinnatum, Equisetum arvense, Equisetum hyemale, Equisetum laevigatum, Equisetum telmateia, Eragrostis cilianensis, Eragrostis pilosa, Eragrostis spectabilis, Erechtites glomeratus, Erechtites minimus, Ericameria nauseosa ssp. nauseosa var. nauseosa, Erigeron annuus, Erigeron karvinskianus, Erigeron philadelphicus, Erigeron strigosus, Eriobotrya japonica, Eriochloa acuminata var. acuminata, Eriochloa contracta, Eriochloa villosa, Eriogonum annuum, Erodium cicutarium, Erysimum cheiranthoides, Erysimum repandum, Eschscholzia californica, Eucalyptus globulus, Eucalyptus robusta, Eugenia uniflora, Euonymus alatus, Euonymus fortunei, Eupatorium altissimum, Eupatorium capillifolium, Euphorbia cyathophora, Euphorbia cyparissias, Euphorbia dentata, Euphorbia esula, Euphorbia esula var. esula, Euphorbia heterophylla, Euphorbia marginata, Euphorbia myrsinites, Euphorbia oblongata, Euphorbia serrata, Euphorbia terracina, Euryops multifidus, Eutrochium fistulosum, Fagopyrum tataricum, Falcataria moluccana, Fatoua villosa, Ficus altissima, Ficus carica, Ficus microcarpa, Ficus rubiginosa, Fimbristylis quinquangularis, Flacourtia indica, Flaveria trinervia, Flueggea acidoton, Foeniculum vulgare, Fragaria virginiana, Frangula alnus, Fraxinus americana, Fraxinus pennsylvanica, Fraxinus uhdei, Froelichia floridana, Froelichia gracilis, Furcraea foetida, Galega officinalis, Galeopsis tetrahit, Galinsoga parviflora, Galinsoga quadriradiata, Galium aparine, Gamochaeta purpurea, Genista monspessulana, Geranium carolinianum, Geranium dissectum, Geranium robe rtianum, Glaucium comiculatum, Glechoma hederacea, Gleditsia triacanthos, Glossostigma cleistanthum, Glossostigma diandrum, Glyceria maxima, Glycine max, Glycyrrhiza lepidota, Gnaphalium palustre, Gossypium hirsutum, Grevillea banksii, Grevillea robusta, Grindelia papposa, Grindelia squarrosa, Gutierrezia sarothrae, Gypsophila paniculata, Haematoxylum campechianum, Halimodendron halodendron, Halo geton glomeratus, Harrisia martinii, Hedeoma hispida, Hedera helix, Hedera hibernica, Hedychium coronarium, Hedychium flavescens, Hedychium gardnerianum, Helenium amarum, Helenium autumnale, Helianthus annuus, Helianthus ciliaris, Helianthus grosseserratus, Helianthus nuttallii, Helianthus petiolaris, Helianthus tuberosus, Helichrysum petiolare, Heliocarpus popayanensis, Heliopsis helianthoides, Hemerocallis fulva, Heracleum mantegazzianum, Heracleum maximum, Hesperis matronalis, Heteranthera limosa, Heteranthera reniformis, Heterocentron subtriplinervium, Heteropogon contortus, Heterotheca subaxillaris, Hibiscus syriacus, Hibiscus tiliaceus, Hibiscus trionum, Hieracium, Hieracium atratum, Hieracium aurantiacum, Hieracium caespitosum, Hieracium canadense, Hieracium xfloribundum, Hieracium laevigatum, Hieracium pilosella, Hieracium piloselloides, Hiptage benghalensis, Hoffmannseggia glauca, Holcus lanatus, Hordeum jubatum, Hordeum murinum ssp. leporinum, Hordeum pusillum, Hordeum vulgare, Humulus japonicus, Hydrilla verticillata, Hydrocharis morsus-range, Hygrophila polysperma, Hymenachne amplexicaulis, Hyoscyamus niger, Hyparrhenia rufa, Hypericum canariense, Hypericum perforatum, Hypochaeris radicata, Hyptis pectinata, Hyptis suaveolens, Ilex aquifolium, Impatiens glandulifera, Impatiens walleriana, Imperata brasiliensis, Imperata brevifolia, Imperata cylindrica, Ipomoea, Ipomoea alba, Ipomoea aquatica, Ipomoea camea ssp. fistulosa, Ipomoea coccinea, Ipomoea cordatotriloba var. cordatotriloba, Ipomoea hederacea, Ipomoea lacunosa, Ipomoea pandurata, Ipomoea purpurea, Ipomoea quamoclit, Ipomoea triloba, Ipomoea turbinata, Ipomoea wrightii, Iris douglasiana, Iris missouriensis, Iris pseudacorus, Isatis tinctoria, Ischaemum rugosum, Iva annua, Iva axillaris, Jacquemontia tamnifolia, Jasminum dichotomum, Jasminum fluminense, Jasminum sambac, Juncus bufonius, Juncus effusus, Juncus planifolius, Juncus polyanthemos, Juncus tenuis, Juniperus virginiana, Kalanchoe pinnata, Kickxia elatine, Koelreuteria elegans, Kummerowia stipulacea, Kummerowia striata, Lactuca floridana, Lactuca serriola, Lactuca tatarica var. pulchella, Lagarosiphon, Lagarosiphon major, Lagascea monis, Lamium amplexicaule, Lamium purpureum, Lamium purpureum var. incisum, Landoltia punctata, Lantana camara, Lappula occidentalis, Lapsana communis, Larrea tridentata, Lathyrus latifolius, Leonurus cardiaca, Lepidium austrinum, Lepidium campestre, Lepidium densiflorum, Lepidium latifolium, Lepidium perfoliatum, Lepidium virginicum, Leptochloa chinensis, Leptochloa fusca ssp. fascicularis, Leptochloa fusca ssp. uninervia, Leptochloa panicoides, Leptospermum scoparium, Lepyrodiclis holosteoides, Lespedeza bicolor, Lespedeza cuneata, Leucaena leucocephala, Leucanthemum vulgare, Ligustrum lucidum, Ligustrum obtusifolium, Ligustrum ovalifolium, Ligustrum sinense, Ligustrum vulgare, Limnobium spongia, Limnocharis flava, Limnophila indica, Limnophila sessiliflora, Linaria dalmatica, Linaria dalmatica ssp. dalmatica, Linaria genistifolia, Linaria vulgaris, Livistona chinensis, Lolium perenne ssp. multiflorum, Lolium temulentum, Lonicera xbella, Lonicera fragrantissima, Lonicera japonica, Lonicera maackii, Lonicera morrowii, Lonicera tatarica, Lonicera xylosteum, Lophostemon confertus, Lotus comiculatus, Ludwigia decurrens, Ludwigia grandiflora ssp. grandiflora, Ludwigia grandiflora ssp. hexapetala, Ludwigia peploides, Lunularia cruciata, Lupinus arboreus, Lupinus perennis, Lupinus plattensis, Lupinus pusillus, Lupinus wyethii, Lychnis flos-cuculi, Lycium barbarum, Lycium ferocissimum, Lycopus americanus, Lygodesmia juncea, Lygodium japonicum, Lygodium microphyllum, Lysimachia nummularia, Lysimachia vulgaris, Lythrum, Lythrum salicaria, Lythrum virgatum, Macaranga mappa, Macaranga tanarius, Macfadyena unguis-cati, Machaeranthera canescens, Machaeranthera pinnatifida ssp. pinnatifida var. pinnatifida, Macleaya cordata, Madia sativa, Mahonia, Malachra alceifolia, Malva neglecta, Malvella leprosa, Marah ore ganus, Marchantia polymorpha ssp. polymorpha, Marrubium vulgare, Marsilea quadrifolia, Matricaria discoidea, Medicago lupulina, Medicago polymorpha, Medicago sativa, Medinilla cummingii, Medinilla magnifica, Medinilla venosa, Melaleuca quinquenervia, Melastoma, Melastoma candidum, Melastoma malabathricum, Melastoma sanguineum, Melia azedarach, Melilotus officinalis, Melinis minutiflora, Melinis repens, Melochia corchorifolia, Melochia umbellata, Mentha arvensis, Mentha xpiperita, Mentha pulegium, Mentha spicata, Mentzelia decapetala, Merremia tuberosa, Mesembryanthemum crystallinum, Miconia, Miconia calvescens, Microlaena stipoides, Microstegium vimineum, Mikania cordata, Mikania micrantha, Mikania scandens, Milium vernale, Mimosa diplotricha, Mimosa pellita, Mirabilis nyctaginea, Miscanthus floridulus, Miscanthus sinensis, Misopates orontium, Mollugo verticillata, Monarda fistulosa, Monarda pectinata, Monochoria hastata, Monochoria vaginalis, Monolepis nuttalliana, Montanoa hibiscifolia, Moraea, Moraea collina, Moraea flaccida, Moraea miniata, Moraea ochroleuca, Moraea pallida, Morella cerifera, Morella faya, Morus alba, Mosla dianthera, Muhlenbergia frondosa, Muhlenbergia racemosa, Muhlenbergia schreberi, Murdannia keisak, Murraya exotica, Muscari botryoides, Muscari comosum, Muscari neglectum, Myoporum laetum, Myosotis scorpioides, Myriophyllum aquaticum, Myriophyllum heterophyllum, Myriophyllum spicatum, Najas minor, Nandina domestica, Nardus stricta, Nassella trichotoma, Nasturtium microphyllum, Nasturtium officinale, Nechamandra altemifolia, Nekemias arborea, Nelumbo lutea, Neonotonia wightii var. wightii, Nepeta cataria, Nephrolepis cordifolia, Nephrolepis multiflora, Neyraudia reynaudiana, Nicandra physalodes, Nicotiana glauca, Nuttallanthus canadensis, Nymphaea mexicana, Nymphaea odorata, Nymphoides peltata, Ochrosia elliptica, Oeceoclades maculata, Oenothera biennis, Oenothera curtiflora, Oenothera laciniata, Oenothera sinuosa, Oenothera suffrutescens, Oenothera xerogaura, Olea europaea, Ononis alopecuroides, Onopordum, Onopordum acanthium, Onopordum acaulon, Onopordum illyricum, Onopordum tauricum, Opuntia aurantiaca, Opuntia fragilis, Opuntia polyacantha, Omithogalum umbellatum, Orobanche, Orobanche cooperi, Orobanche minor, Orobanche ramosa, Oryza longistaminata, Oryza punctata, Oryza rufipogon, Oryza sativa, Ottelia alismoides, Oxalis corniculata, Oxalis stricta, Oxyspora paniculata, Oxytropis lambertii, Oxytropis sericea, Packera glabella, Paederia cruddasiana, Paederia foetida, Panicum antidotale, Panicum capillare, Panicum dichotomiflorum, Panicum miliaceum, Panicum repens, Panicum virgatum, Papaver dubium, Papaver somnife rum, Paraderris elliptica, Paraserianthes lophantha ssp. montana, Parietaria pensylvanica, Parthenium hysterophorus, Parthenocissus quinquefolia, Paspalum conjugatum, Paspalum denticulatum, Paspalum dilatatum, Paspalum laeve, Paspalum notatum, Paspalum scrobiculatum, Paspalum urvillei, Passiflora bicornis, Passiflora biflora, Passiflora edulis, Passiflora foetida, Passiflora incarnata, Passiflora laurifolia, Passiflora ligularis, Passiflora lutea, Passiflora suberosa, Passiflora tarminiana, Passiflora tripartita var. mollissima, Pastinaca sativa, Paulownia tomentosa, Peganum harmala, Pennisetum ciliare, Pennisetum clandestinum, Pennisetum macrourum, Pennisetum pedicellatum, Pennisetum polystachion, Pennisetum purpureum, Pennisetum setaceum, Perilla frutescens, Phalaris aquatica, Phalaris arundinacea, Phalaris canariensis, Phalaris minor, Phleum pratense, Phoenix reclinata, Phormium tenax, Phragmites australis, Phyllanthus tenellus, Phyllanthus urinaria, Phyllostachys aurea, Phyllostachys nigra, Physalis acutifolia, Physalis angulata, Physalis heterophylla, Physalis longifolia, Physalis longifolia var. subglabrata, Physalis virginiana, Physalis viscosa, Phytolacca americana, Picris hieracioides, Pimenta dioica, Pimenta racemosa, Pinus elliottii var. elliottii, Pinus patula, Pinus pinaster, Pinus radiata, Pinus taeda, Piper aduncum, Pistia stratiotes, Pittosporum undulatum, Plantago aristata, Plantago lanceolata, Plantago major, Plantago patagonica, Plantago rugelii, Pluchea carolinensis, Pluchea indica, Poa annua, Poa bulbosa, Poa compressa, Poa pratensis, Poa trivialis, Polygonatum biflorum, Polygonum achoreum, Polygonum amphibium, Polygonum arenastrum, Polygonum aviculare, Polygonum cespitosum, Polygonum convolvulus, Polygonum cuspidatum, Polygonum erectum, Polygonum lapathifolium, Polygonum orientale, Polygonum pensylvanicum, Polygonum perfoliatum, Polygonum persicaria, Polygonum polystachyum, Polygonum ramosissimum, Polygonum sachalinense, Polypogon monspeliensis, Pontederia cordata, Pontederia rotundifolia, Populus alba, Populus deltoides, Portulaca oleracea, Potamogeton crispus, Potentilla recta, Potentilla simplex, Proboscidea louisianica, Prosopis, Prosopis alpataco, Prosopis argentina, Prosopis burkartii, Prosopis caldenia, Prosopis calingastana, Prosopis campestris, Prosopis castellanosii, Prosopis denudans, Prosopis elata, Prosopis farcta, Prosopis ferox, Prosopis fiebrigii, Prosopis glandulosa, Prosopis hassleri, Prosopis humilis, Prosopis juliflora, Prosopis kuntzei, Prosopis pallida, Prosopis palmeri, Prosopis reptans, Prosopis rojasiana, Prosopis ruizlealii, Prosopis ruscifolia, Prosopis sericantha, Prosopis strombulifera, Prosopis torquata, Prosopis velutina, Prunella vulgaris, Prunus serotina, Prunus virginiana, Psidium cattleianum, Psidium guajava, Pteridium aquilinum, Pteridium aquilinum var. pubescens, Pteris vittata, Ptychosperma elegans, Pueraria montana, Pueraria montana var. lobata, Pueraria phaseoloides, Pyrrhopappus carolinianus, Ranunculus abortivus, Ranunculus acris, Ranunculus arvensis, Ranunculus bulbosus, Ranunculus ficaria, Ranunculus repens, Ranunculus sardous, Raphanus raphanistrum, Raphanus sativus, Retama monosperma, Rhamnus, Rhamnus cathartica, Rhizophora mangle, Rhodomyrtus tomentosa, Rhus glabra, Rhus typhina, Rhynchospora caduca, Rhynchospora corniculata, Ribes, Richardia scabra, Ricinus communis, Robinia pseudoacacia, Rorippa austriaca, Rorippa palustris, Rorippa sinuata, Rorippa sylvestris, Rosa arkansana, Rosa multiflora, Rosa rugosa, Rottboellia cochinchinensis, Rubus argutus, Rubus armeniacus, Rubus ellipticus var. obcordatus, Rubus fruticosus, Rubus glaucus, Rubus laciniatus, Rubus moluccanus, Rubus niveus, Rubus phoenicolasius, Rubus rosifolius, Rubus sieboldii, Rudbeckia hirta, Ruellia caerulea, Rumex, Rumex acetosella, Rumex altissimus, Rumex crispus, Rumex obtusifolius, Saccharum spontaneum, Sacciolepis indica, Sagina procumbens, Sagittaria graminea, Sagittaria latifolia, Sagittaria montevidensis, Sagittaria sagittifolia, Salsola, Salsola collina, Salsola kali, Salsola paulsenii, Salsola tragus, Salsola vermiculata, Salvia aethiopis, Salvia lyrata, Salvia pratensis, Salvia reflexa, Salvia sclarea, Salvia xsuperba, Salvinia, Salvinia auriculata, Salvinia biloba, Salvinia herzogii, Salvinia molesta, Sansevieria hyacinthoides, Saponaria officinalis, Sarcobatus vermiculatus, Saururus cernuus, Scaevola sericea, Schedonnardus paniculatus, Schedonorus arundinaceus, Schedonorus pratensis, Schefflera actinophylla, Schinus molle, Schinus terebinthifolius, Schismus arabicus, Schismus barbatus, Schizachyrium condensatum, Schoenoplectiella mucronata, Schoenoplectus acutus var. acutus, Scleranthus annuus, Sclerochloa dura, Scolymus, Scolymus hispanicus, Scoparia dulcis, Secale cereal, Securigera varia, Senecio jacobaea, Senecio madagascariensis, Senecio riddellii, Senecio squalidus, Senecio vulgaris, Senna obtusifolia, Senna occidentalis, Senna pendula var. glabrata, Sesbania herbacea, Sesbania punicea, Setaria faberi, Setaria italica, Setaria palmifolia, Setaria parviflora, Setaria pumila, Setaria pumila ssp. pallidefusca, Setaria pumila ssp. pumila, Setaria verticillata, Setaria viridis, Sibara virginica, Sicyos angulatus, Sida rhombifolia, Sida spinosa, Silene conoidea, Silene latifolia ssp. alba, Silene noctiflora, Silene vulgaris, Silphium perfoliatum, Silybum, Silybum marianum, Sinapis, Sinapis arvensis ssp. arvensis, Sisymbrium altissimum, Sisymbrium irio, Sisymbrium loeselii, Sisymbrium officinale, Smilax rotundifolia, Solanum americanum, Solanum cardiophyllum, Solanum carolinense, Solanum dimidiatum, Solanum diphyllum, Solanum dulcamara, Solanum elaeagnifolium, Solanum jamaicense, Solanum lanceolatum, Solanum marginatum, Solanum nigrum, Solanum physalifolium, Solanum ptycanthum, Solanum robustum, Solanum rostratum, Solanum tampicense, Solanum torvum, Solanum triflorum, Solanum viarum, Solidago altissima, Solidago canadensis, Solidago missouriensis, Soliva sessilis, Sonchus arvensis, Sonchus arvensis ssp. arvensis, Sonchus arvensis ssp. uliginosus, Sonchus asper, Sonchus oleraceus, Sorghastrum nutans, Sorghum almum, Sorghum bicolor, Sorghum halepense, Sorghum propinquum, Sparganium erectum, Spartina altemiflora, Spartina anglica, Spartina densiflora, Spartina patens, Spartium junceum, Spathodea campanulata, Spergula arvensis, Spermacoce alata, Sphaeralcea coccinea, Sphaerophysa salsula, Sphagneticola trilobata, Sphenoclea zeylanica, Spiraea japonica, Sporobolus cryptandrus, Sporobolus indicus, Sporobolus vaginiflorus, Stachys floridana, Stellaria graminea, Stellaria media, Stratiotes abides, Striga, Striga asiatica, Symphoricarpos occidentalis, Symphyotrichum divaricatum, Symphyotrichum ericoides var. ericoides, Symphyotrichum pilosum var. pilosum, Symphytum asperum, Syngonium podophyllum, Syzygium cumini, Syzygium jambos, Taeniathe rum caput-medusae, Tagetes minuta, Tamarix, Tamarix aralensis, Tamarix chinensis, Tamarix gallica, Tamarix parviflora, Tamarix ramosissima, Tanacetum vulgare, Taraxacum officinale, Tectaria incisa, Terminalia catappa, Tetradymia canescens, Tetragonia tetragonioides, Tetrastigma voinieranum, Tetrazygia bicolor, Teucrium canadense, Themeda villosa, Thermopsis rhombifolia, Thespesia populnea, Thlaspi arvense, Thymelaea passerina, Thymus praecox ssp. arcticus, Tibouchina, Tibouchina herbacea, Tibouchina longifolia, Tibouchina urvilleana, Toona ciliata, Torilis arvensis, Toxicodendron pubescens, Toxicodendron radicans, Toxicodendron radicans ssp. radicans, Toxicodendron rydbergii, Toxicodendron vernix, Tradescantia fluminensis, Tradescantia spathacea, Tragopogon dubius, Trapa, Trapa natans, Trema orientalis, Triadica sebifera, Trianthema portulacastrum, Tribulus cistoides, Tribulus terrestris, Tridax procumbens, Trifolium arvense, Trifolium campestre, Trifolium incarnatum, Trifolium repens, Triglochin maritima, Triodanis perfoliata, Triphasia trifolia, Tripleurospermum perforatum, Tripsacum dactyloides, Triticum aestivum, Triumfetta rhomboidea, Triumfetta semitriloba, Tussilago farfara, Typha latifolia, Ulex europaeus, Ulmus parvifolia, Ulmus pumila, Urena lobata, Urochloa fusca, Urochloa maxima, Urochloa mutica, Urochloa panicoides, Urochloa platyphylla, Urochloa ramosa, Urochloa texana, Urtica dioica, Urtica dioica ssp. gracilis, Utricularia inflata, Vaccaria hispanica, Vachellia famesiana, Valeriana officinalis, Valerianella radiata, Ventenata dubia, Veratrum califomicum, Verbascum blattaria, Verbascum thapsus, Verbena bracteata, Verbena hastata, Verbena stricta, Verbena urticifolia, Verbesina encelioides, Vemicia fordii, Vernonia baldwinii, Vemonia gigantea, Veronica agrestis, Veronica arvensis, Veronica biloba, Veronica filiformis, Veronica peregrina, Veronica persica, Viburnum lantana, Viburnum opulus, Vicia sativa ssp. nigra, Vicia tetrasperma, Vicia villosa, Vigna unguiculata, Vinca major, Vinca minor, Viola arvensis, Viola nephrophylla, Viola sororia, Viscum album, Vitis, Vitis aestivalis, Vitis labrusca, Vitis riparia, Vitis vulpina, Vossia cuspidata, Vulpia myuros, Vulpia octoflora, Wisteria floribunda, Wisteria sinensis, Xanthium, Xanthium spinosum, Xanthium strumarium, Xanthium strumarium var. canadense, Xylorhiza glabriuscula, Yucca glauca, Zea mays, Zigadenus venenosus and Zygophyllum fabago.

In an aspect, methods and compositions of the present invention are used to control annual grasses belonging to the genera Bromus, Ventenata, Taeniatherum, Secale, and Aegilops.

In another aspect, methods and compositions of the present invention are used to control Bromus tectorum (cheatgrass or downy brome), Bromus rubens (red brome), Bromus secalinus (cheat) and Bromus japonicus (Japanese brome), Ventenata dubia (ventenata), Taeniathe rum caput-medusae (medusahead), Secale cereal (feral rye), Aegilops triuncialis (barb goatgrass), and Aegilops cylindrica (jointed goatgrass).

This application incorporates by reference PCT Publication WO 2009/100500 A1 and is relied upon for all purposes, e.g., support claims. This application incorporates US Application Publication 2017/0034997 A1 and is relied upon for all purposes, e.g., support for claims.

The following examples serve to illustrate certain aspects of the disclosure and are not intended to limit the disclosure.

### Example

A crop of soybeans is grown infested with Palmer Amaranth. The soybean crop is grown to harvest and the Palmer amaranth is in the seed stage, just before seed drop. A combine harvester equipped with a follow-along seed pulverizer as described in WO 2009/100500 A is used to harvest the crop. The seed pulverizer is fitted with a liquid applicator at the expelling end to treat crop residue material expelled from the pulverizer with a diluted indaziflam suspension concentrate—before the expelled material touches the ground—such that the combine harvester-pulverizer deposits treated crop residue material such that the land so harvested is treated with about 1 g of indaziflam per hectare of spread crop residue material, without treating the land directly.

In the next growing season, another soybean crop has less than 10% of the volume of Palmer Amaranth compared to the present soybean harvest.

### Embodiments

1. A method for preventing seed germination, comprising applying a seed-germinating preventative amount of an herbicidal composition to a seedhead of a plant in a reproductive stage of growth.

2. The method according to embodiment 1, wherein the plant is a monocotyledon.

3. The method according to embodiment 1 or 2, wherein the plant is cheatgrass, ventenata, medusahead, jointed goatgrass, barbed goatgrass, sandbur. 4. A method for preventing germination of a seed or for destroying a plant from which the seed grows, the method comprising applying to the seed, while harvesting or destroying a plant from which the seed has been produced, a seed-germination preventative amount and/or a plant-destroying amount of an herbicidal composition.

5. The method according to embodiment 4, wherein the plant from which the seed has been produced is harvested and/or destroyed while, or after, harvesting a crop at a locus where the plant had been growing before the harvesting.

6. The method according to embodiment 4 or 5, wherein the plant is an invasive grass.

7. The method according to embodiment 6, wherein the invasive grass is selected from the group consisting of buffelgrass, cheatgrass, ventenata, medusahead, vaseygrass, sandbur, crabgrass, and jointed goatgrass.

8. The method according to embodiment 4 or 5, wherein the plant is an invasive broadleaf.

9 The method according to embodiment 8, wherein the invasive broadleaf is selected from the group consisting of pigweed, kochia, waterhemp, Palmer amaranth, and Russian thistle.

10. The method of any one of embodiments 5-9, wherein the crop is cotton, soybean, wheat, or corn.

11. The method of any one of embodiments 5-10, wherein the herbicide is applied at a rate of from about 1 to about 50 g ai/ha.

12. The method of embodiment 11, wherein the herbicide is applied at a rate from about 2 to about 50 g ai/ha, from about 2 to about 40 g ai/ha, from about 2 to about 35 g ai/ha, from about 2 to about 30 g/ha, from about 2 to about 25 g ai/ha, from about 2 to about 20 g ai/ha, from about 2 to about 15 g ai/ha, from about 2 to about 10 g ai/ha, from about 2 to about 5 g ai/ha, from about 5 to about 50 g ai/ha, from about 5 to about 40 g ai/ha, from about 5 to about 35 g ai/ha, from about 5 to about 30 g ai/ha, from about 5 to about 25 g ai/ha, from about 5 to about 20 g ai/ha, from about 5 to about 15 g ai/ha, from about 5 to about 10 g ai/ha, from about 10 to about 50 g ai/ha, from about 10 to about 40 g ai/ha, from about 10 to about 35 g ai/ha, from about 10 to about 30 g ai/ha, from about 10 to about 25 g ai/ha, from about 10 to about 20 g ai/ha, from about 10 to about 15 g ai/ha, from about 15 to about 50 g ai/ha, from about 15 to about 40 g ai/ha, from about 15 to about 35 g ai/ha, from about 15 to about 30 g ai/ha, from about 15 to about 25 g ai/ha, from about 15 to about 20 g ai/ha, from about 20 to about 50 g ai/ha, from about 20 to about 40 g ai/ha, from about 20 to about 35 g ai/ha, from about 20 to about 30 g ai/ha, from about 20 to about 25 g ai/ha, from about 25 to about 50 g ai/ha, from about 25 to about 40 g ai/ha, from about 25 to about 35 g ai/ha, or from about 25 to about 30 g ai/ha.

13. The method of any one of embodiments 1-12, wherein the herbicidal composition comprises indaziflam.

14. The method of embodiment 13, wherein indaziflam is the sole active ingredient of the herbicidal composition.

15. An apparatus adapted to travel on the ground with a crop harvesting machine, or integrated with a crop harvesting machine, the apparatus configured to be positioned in an output stream of a crop residue material produced by the harvesting machine, the apparatus comprising an input port to receive the crop residue material and an applicator configured to apply a liquid to the crop residue.

16. The apparatus of embodiment 15 wherein the apparatus further comprises a mill for fragmentation of the crop residue material to provide a fragmented crop residue.

17. The apparatus of embodiment 15 or 16, wherein the applicator is configured to apply one or more streams of liquid to the crop residue.

18. The apparatus of any one of embodiments 15-18, wherein the applicator is configured to apply an aspirated liquid to the fragmented crop residue.

19. The apparatus of any one of embodiments 15-18, wherein the liquid is an agrochemically acceptable liquid.

20. The apparatus of any one of embodiments 15-19, wherein the liquid comprises indaziflam.

21. The apparatus of any one of embodiments 15-20, wherein the apparatus is configured to apply indaziflam at a rate of from about 1 g to about 50 g ai/ha of indaziflam as the crop harvesting machine deposits crop residue material about the traveled land.

22. The apparatus of embodiment 21, wherein the apparatus is configured to apply indaziflam at a rate from about 2 to about 50 g ai/ha, from about 2 to about 40 g ai/ha, from about 2 to about 35 g ai/ha, from about 2 to about 30 g/ha, from about 2 to about 25 g ai/ha, from about 2 to about 20 g ai/ha, from about 2 to about 15 g ai/ha, from about 2 to about 10 g ai/ha, from about 2 to about 5 g ai/ha, from about 5 to about 50 g ai/ha, from about 5 to about 40 g ai/ha, from about 5 to about 35 g ai/ha, from about 5 to about 30 g ai/ha, from about 5 to about 25 g ai/ha, from about 5 to about 20 g ai/ha, from about 5 to about 15 g ai/ha, from about 5 to about 10 g ai/ha, from about 10 to about 50 g ai/ha, from about 10 to about 40 g ai/ha, from about 10 to about 35 g ai/ha, from about 10 to about 30 g ai/ha, from about 10 to about 25 g ai/ha, from about 10 to about 20 g ai/ha, from about 10 to about 15 g ai/ha, from about 15 to about 50 g ai/ha, from about 15 to about 40 g ai/ha, from about 15 to about 35 g ai/ha, from about 15 to about 30 g ai/ha, from about 15 to about 25 g ai/ha, from about 15 to about 20 g ai/ha, from about 20 to about 50 g ai/ha, from about 20 to about 40 g ai/ha, from about 20 to about 35 g ai/ha, from about 20 to about 30 g ai/ha, from about 20 to about 25 g ai/ha, from about 25 to about 50 g ai/ha, from about 25 to about 40 g ai/ha, from about 25 to about 35 g ai/ha, or from about 25 to about 30 g ai/ha of indaziflam as the crop harvesting machine deposits crop residue material about the traveled land.

1. A method for preventing seed germination, comprising applying a seed-germinating preventative amount of an herbicidal composition to a seedhead of a plant in a seedhead growth stage.

2. The method according to claim 1, wherein the plant is a monocotyledon.

3. The method according to claim 1, wherein the plant is cheatgrass, ventenata, medusahead, jointed goatgrass, barbed goatgrass, or sandbur.

4. A method for preventing germination of a seed or for destroying a plant from which the seed grows, the method comprising applying to the seed, while harvesting or destroying a plant from which the seed has been produced, a seed-germination preventative amount and/or a plant-destroying amount of an herbicidal composition.

5. The method according to claim 4, wherein the plant from which the seed has been produced is harvested and/or destroyed while, or after, harvesting a crop at a locus where the plant had been growing before the harvesting.

6. The method according to claim 4, wherein the plant is an invasive grass.

7. The method according to claim 6, wherein the invasive grass is selected from the group consisting of buffelgrass, cheatgrass, ventenata, medusahead, vaseygrass, sandbur, crabgrass, and jointed goatgrass.

8. The method according to claim 4, wherein the plant is an invasive broadleaf.

9. The method according to claim 8, wherein the invasive broadleaf is selected from the group consisting of pigweed, kochia, waterhemp, Palmer amaranth, and Russian thistle.

10. The method of claim 5, wherein the crop is cotton, soybean, wheat, or corn.

11. The method of claim 5, wherein the herbicidal composition is applied at a rate of from about 1 to about 50 g ai/ha.

12. The method of claim 1, wherein the herbicidal composition comprises indaziflam.

13. The method of claim 12, wherein indaziflam is the sole active ingredient of the herbicidal composition.

14. An apparatus adapted to travel on the ground with a crop harvesting machine, or integrated with a crop harvesting machine, the apparatus configured to be positioned in an output stream of a crop residue material produced by the harvesting machine, the apparatus comprising an input port to receive the crop residue material and an applicator configured to apply a liquid to the crop residue.

15. The apparatus of claim 14 wherein the apparatus further comprises a mill for fragmentation of the crop residue material to provide a fragmented crop residue.

16. The apparatus of claim 14, wherein the applicator is configured to apply one or more streams of liquid to the crop residue.

17. The apparatus of claim 14, wherein the applicator is configured to apply an aspirated liquid to the fragmented crop residue.

18. The apparatus of claim 14, wherein the liquid is an agrochemically acceptable liquid.

19. The apparatus of claim 14, wherein the liquid comprises indaziflam.

20. The apparatus of claim 14, wherein the apparatus is configured to apply indaziflam at a rate of from about 1 g to about 50 g ai/ha of indaziflam as the crop harvesting machine deposits crop residue material about the traveled land.
